(19) United States
(12) Patent Application Publication
(10) Pub. No.: US 2008/0288320 A1
(43) Pub. Date: Nov. 20, 2008

(54) ACTIONABLE BUSINESS PLAN CREATION AND EXECUTION

(76) Inventors: Jay R. Ockers, Fort Collins, CO (US); Bernard C. Lee, Fort Collins, CO (US)

Correspondence Address: COCHRAN FREUND & YOUNG LLC, 2026 CARIBOU DR, SUITE 201, FORT COLLINS, CO, 80525, US

(21) Appl. No.: 11/750,166

(22) Filed: May 17, 2007

(51) Int. Cl. G06F 9/46

(52) U.S. Cl. 705/9

(57) ABSTRACT

Disclosed is a system and method for creating and executing business plans. A business plan is created as an actionable business plan using an interactive knowledgebase. The actionable business plan is stored in an electronic format using a hierarchical parent/child storage structure, such as a structure that may be created in a database. The actionable business plan is presented to a user for reporting and maintenance through an interactive Graphical User Interface (GUI). The system and method may further support managing multiple business plans on a single system by placing each individual actionable business plan into a separate folder. The folders may be incorporated as an extension of the hierarchical parent/child structure of an actionable business plan. Each folder and the associated child business plan elements may have unique access permissions such that each individual user is presented with the business plan elements that are related to folders that the individual has permission to access. The system and method may also support tracking a business plan that spans multiple quarters with an ability to focus on plan elements that occur within a definable range of quarters and then view calculated weighted progress for the specified range of quarters. The system and method may generate an interactive report that shows all business plan elements that span the specified quarters. Two primary reports are a weighted average for all business plan actions that are due during the chosen quarters and a weighted average for all business plan actions due throughout the entire course of the business plan.

### BACKGROUND OF THE INVENTION

A business plan is a document that describes a company's expected course of action over a specified period of time. To achieve the expected course of action, the business plan describes the objectives, strategies, market and financial forecast of the business. Typically a business plan is created in an effort to raise venture capital or to obtain financing. Thus, a typical business plan is created as a static document to market to potential investors. After money has been invested, the business plan is executed to achieve the objectives of the plan. The coordination of the activities and processes necessary to achieve the objectives of the business plan may be very difficult, particularly for small to medium size businesses without established systems in place to manage business operations.

A business may hold planning meetings, distribute documents, send e-mails to assign key deliverables and report on tactics in an effort to execute a business plan. Frequently, no one is driving the process from start to finish. Many times, the execution of the business plan is managed using a patchwork of different tools that may or may not interconnect. Further, the patchwork of tools used to execute a business plan creates a very complex system. Key deliverables may be defined in individual documents or buried in e-mails. Accountability for objectives may be maintained in multiple locations or by multiple tools. The business may hold live meetings that generate enthusiasm, intermediate goals and action plans, but business plan execution may still flounder when deliverables get lost in the shuffle of day-to-day business activities.

### SUMMARY OF THE INVENTION

An embodiment of the present invention may comprise a method to create and execute an actionable business plan comprising: creating a business plan storage structure on a computer readable storage medium, the computer readable storage system being part of a computer system; gathering business plan information for the actionable business plan from a business plan construction user by having an interactive knowledgebase guide the business plan construction user through a series of questions where suitable questions are selected based on prior responses to previous questions; separating the business plan information into separate business elements to create actionable business elements; dynamically linking the actionable business elements to related actionable business elements; storing the business plan information in the business plan storage structure employing a hierarchical parent/child storage structure such that an actionable business element that is a piece of a parent element is stored as a child element of the parent element; presenting the actionable business plan to end users via a Graphical User Interface (GUI); assigning the actionable business elements to individuals for execution of the actionable business elements by the assigned individuals; and communicating progress towards completion of the actionable business elements on an ongoing basis.

An embodiment of the present invention may further comprise an actionable business plan creation and execution system comprising: a computer system containing a computer readable storage medium that stores a business plan storage structure; a business plan information gathering subsystem that gathers business plan information for the actionable business plan from a business plan construction user by having an interactive knowledgebase guide the business plan construction user through a series of questions where suitable questions are selected based on prior responses to previous questions; an actionable business elements subsystem that separates the business plan information into separate business elements to create actionable business elements, dynamically links the actionable business elements to related actionable business elements, and stores the business plan information in the business plan storage structure employing a hierarchical parent/child storage structure such that an actionable business element that is a piece of a parent element is stored as a child element of the parent element; and a user interaction subsystem that presents the actionable business plan to end users via a Graphical User Interface (GUI), permits end users to assign the actionable business elements to individuals for execution of the actionable business elements by the assigned individuals, and communicates progress towards completion of the actionable business elements on an ongoing basis.

An embodiment of the present invention may further comprise an actionable business plan creation and execution system comprising: means for creating a business plan storage structure on a computer readable storage medium, the computer readable storage system being part of a computer system; means for gathering business plan information for the actionable business plan from a business plan construction user; means for separating the business plan information into separate business elements to create actionable business elements; means for dynamically linking the actionable business elements to related actionable business elements; means for storing the business plan information in the business plan storage structure; means for presenting the actionable business plan to end users; means for assigning the actionable business elements to individuals for execution of the actionable business elements by the assigned individuals; and means for communicating progress towards completion of the actionable business elements.

### BRIEF DESCRIPTION OF THE DRAWINGS

In the drawings,

FIG. 1 is a flow chart describing a top-level view of the process for the creation and execution of an actionable business plan.

FIG. 2 is a flowchart describing a top-level view of the process for storing and managing multiple actionable business plans on a single system.

FIG. 3 is a flowchart describing a top-level view of the process for creating and tracking an actionable business plan that spans multiple quarters.

FIG. 4 is the first page of a flowchart describing a detailed view of the process for the creation of an actionable business plan.

FIG. 5 is the second page of the flowchart describing the detailed view of the process for the creation of an actionable business plan.

FIG. 6 is a flowchart describing a detailed view of the process for saving an actionable business plan to a temporary storage location.

FIG. 7 is a flowchart describing a detailed view of the process for saving an actionable business plan to a database.

FIG. 8 is a flowchart describing a detailed view of the process for storing and managing multiple actionable business plans on a single system.

FIG. 9 is a flowchart describing a detailed view of the process for creating and tracking a business plan that spans multiple quarters.

### DETAILED DESCRIPTION OF THE INVENTION

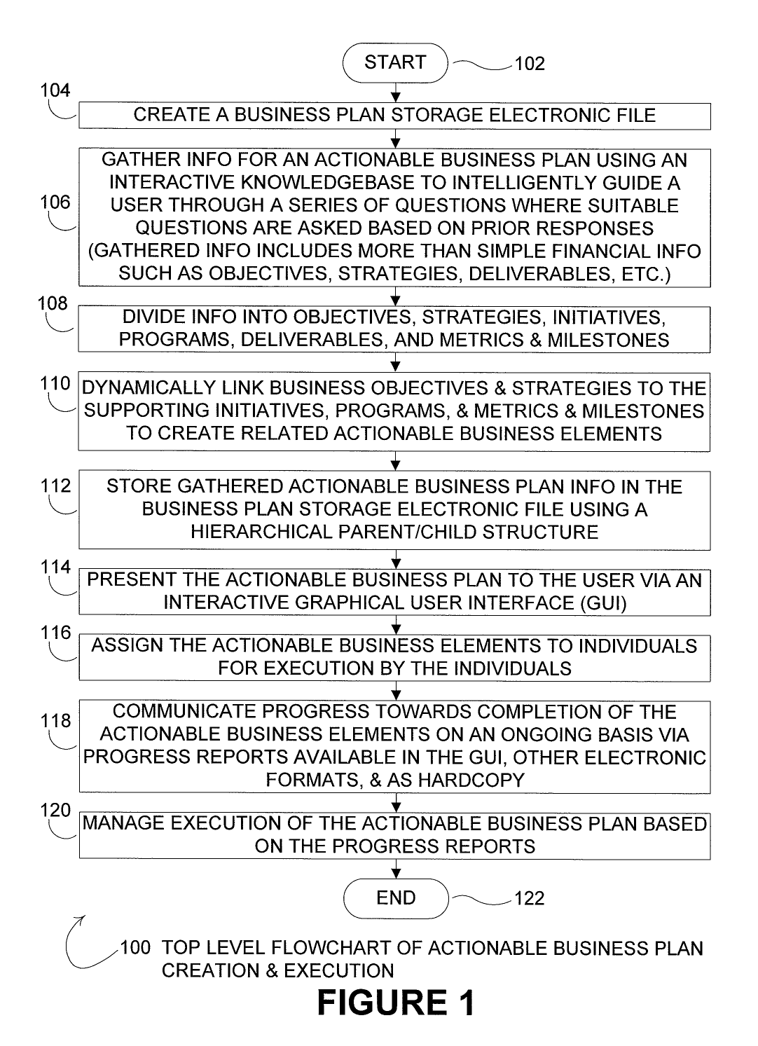

FIG. 1 is a flow chart 100 describing a top-level view of the process for the creation and execution of an actionable business plan. To start 102, a business plan storage electronic file is created and stored on a computer readable medium 104. The electronic file is capable of storing information using a parent/child hierarchy. A database system may be used to implement the storage of the business plan data. Other storage schemes may include binary formatted files, text formatted files, a plurality of related electronic files, and/or using other computer readable data storage schemes. Continuing with the creation and execution of the actionable business plan, the next step 106 gathers information that will be included in the actionable business plan using an interactive knowledge base to guide a user through a series of questions. Questions may be standard “business” creation and operation questions as well as more specific questions that relate to previously answered questions. Some typical standard questions might include: what type of business plan structure does/will the business want, what departments does/will the business have (i.e., Human Resources, Sales, Marketing, Engineering, etc.), etc. Follow-up questions may be based on responses to prior questions such that the system intelligently leads the use through the creation of the actionable business plan. For example, if the user indicates that the business does/will have a human resources department, some follow-up questions may include issues around employee benefits, payroll issues, etc. Responses to questions may be limited to a predetermined set of possible answers. For instance, responses for what departments will the business have may be limited to Human Resources, Sales, Marketing, Accounting, and Engineering. The user may be able to add or delete potential responses from the list of predetermined answers. For instance, the user may add Manufacturing to the list of possible departments or the user may delete Engineering as a possible choice for departments. The ability to edit the lists of possible answers is especially useful for a business consultant or other user that creates multiple business plans and wants to customize the system to match the user's general approach to business operations.

Information gathered for the actionable business plan includes more than simple financial information. In addition to financial information, information on business objectives, strategies, deliverables, and other important business criteria may be obtained during the information gathering step 106. The business plan information gathered in step 106 is then divided into distinct business elements such as objectives, strategies, initiatives, programs, deliverables, and metrics and milestones 108. Each business element becomes an actionable business element when stored in the actionable business plan. At step 110, the distinct business elements identified in step 106 are dynamically linked to create related actionable business elements. For instance, business objectives and strategies may be linked to initiatives, programs, and/or metrics and milestones that support the business objectives and strategies. The actionable business elements of step 110 are stored in the business plan storage electronic file of step 104 using a hierarchical parent/child structure to mimic the parent/child relationship of the actionable business elements 108 such that an actionable business element that is a piece of a parent element is stored as a child element of the parent element. The actionable business plan is then presented to the user via an interactive Graphical User Interface (GUI) 114. The user then assigns the actionable business elements to individuals for execution by the assigned individual 116. Additional due dates may also be gathered when individuals are assigned to an actionable business element. At step 118, progress towards completion of the actionable items is reported to users via progress reports. The group of users with access to the system may include anyone with a vested interest in the business plan. Progress reports may be delivered and/or viewed in a variety of ways such as via the GUI, e-mail, facsimile, some other electronic communication format, and/or as hardcopy. Using the reports and the GUI, the users of the system, or a subset thereof, manage the business based on the actionable business plan and the associated reports generated for the actionable business plan 120. Once the actionable business elements are completed, the creation and execution of the business plan is ended 122.

When the actionable business plan is created, the business elements are broken down into manageable, actionable business elements as performed in steps 106, 108, and 110. Per steps 108, 110 and 112, the actionable business elements are hierarchically related into a parent/child hierarchy and are stored on the computer with the same parent/child relationships intact. Thus, the relations between elements are readily apparent to a user and are inherent to the structure of the actionable business plan. Within the same system that the business elements are defined, the responsibilities and due dates are assigned to each business element in steps 114 and 116. By creating the business plan as an actionable business plan, the business plan becomes an active tool that may be used to manage the execution of the business plan and not just a document to give to potential investors when trying to raise capital. The reports of step 118 and the GUI of step 114 allow visibility into the individual business elements of a business plan, and the progress towards completion for the business elements. The reports may be interactive and permit live updates of progress as information becomes available. The live reports may also be used to permit up-to-the-minute reports for use in tracking meetings and other important presentations. The GUI showing the reports may be made available via a standard web browser so that a traveling user has access to the system anywhere an Internet connection is available. Progress tracking may come with alarms that trigger when progress begins to slip or when a due date is coming up. As progress slips further, alarms may be escalated to higher levels, such as medium (yellow) and high (red) elevated alarms. The responsible individuals for a late business element, as assigned in step 116, may be held accountable for the slip in the schedule.

Visibility into the business plan may be controlled to ensure that individuals only have access to data that concerns each individual's job function. Each business element may be assigned access permission rules. Each user may be given certain permission levels to permit access to various business elements. Based on the access permission rules for the business element and the access permission levels assigned to the individual, access may be permitted, denied, or permitted in part. Hence, access to the business plan may be restricted to an individual's role-based need to access specific data. Each individual may be given a unique view in the GUI to show the business elements and progress relevant to the individual. Thus, the user interface is not cluttered with non-relevant information and access to sensitive material may be restricted to properly authorized persons. Higher level managers or other authorized users may be permitted to access views for other people in order to monitor progress for the other people. The reports made available in step 118 may also be controlled by similar access permission rules and permission levels to ensure that each person has access to the proper information.

Various embodiments of the actionable business plan permit true management oversight by providing visibility into the plan and the accountability necessary to complete the plan. The actionable business plan further aids in the development of business processes by clearly defining business elements, tracking the progress toward completion of the business elements, and making the appropriate individuals accountable for progress on the business elements. The actionable business plan both simplifies and makes communication of the progress and structure of the business elements of a business plan much more robust. By clearly communicating the business elements, individuals responsible for specific business elements, and the progress towards completion of the business elements, the actionable business plan system provides the visibility and accountability necessary for proper oversight and management of the business plan execution.

The various embodiments of the actionable business plan permit the creation and execution of a business plan using a single software system that may be run on a single computer system. The system may also be connected to the Internet so that the GUI and the reports are available to non-local users. The software system may also be made available twenty-four hours a day, seven days a week to ensure that all interested parties have quick and easy access to the management and tracking tools needed to execute the business plan. Poorly executed business plans may be the death knell for many businesses, especially small to medium size businesses that do not have enough financial inertia to stay viable while waiting to achieve the objectives and strategies of a business plan. Using an actionable business plan avoids spreading action items and deliverables management across a variety of tools such as e-mail, power point presentations, and others. By using one tool, the system is simple and less complex than using multiple tools to track and manage the execution of a business plan. No longer is a key deliverable in a document that is buried in a string of e-mails. Instead, there is one system that tracks and reports on the progress for all of the key business elements for a business plan.

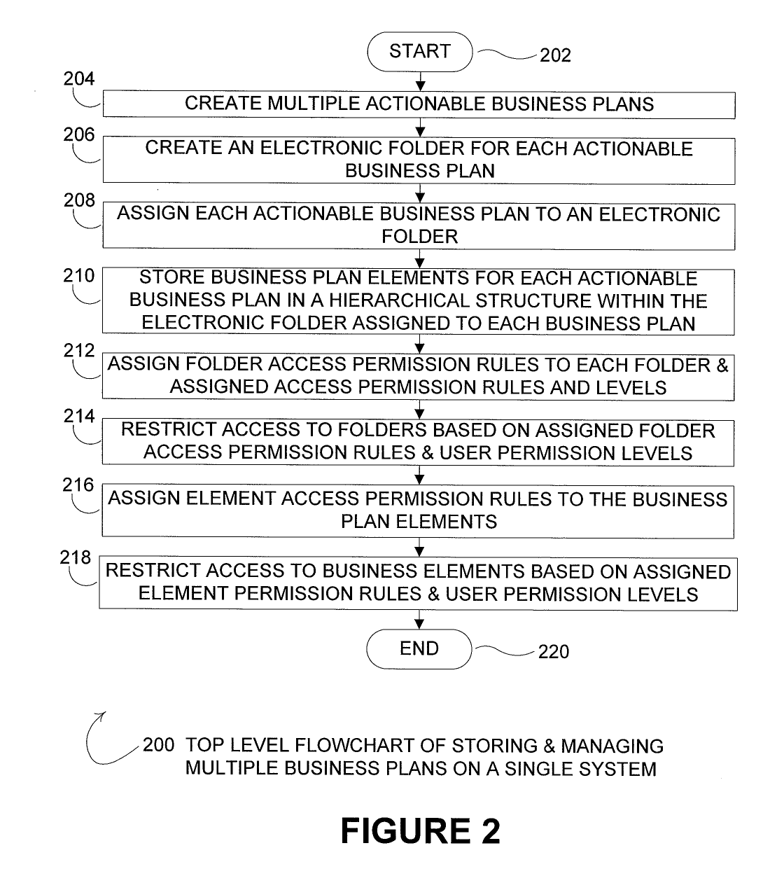

FIG. 2 is a flowchart 200 describing a top-level view of the process for storing and managing multiple actionable business plans on a single system. To start 202, create multiple actionable business plans 204. The steps to create multiple actionable business plans are to repeat the step described in the disclosure with respect to FIG. 1 for each desired business plan. An electronic folder is created on a computer readable medium for each actionable business plan 206. Each actionable business plan is assigned to one of the newly created electronic folders 208 and the actionable business plan assigned to each electronic folder is stored within the assigned electronic folder 210. The parent/child hierarchy of each actionable business plan is preserved when the actionable business plan is stored in the assigned electronic folder such that the hierarchical structure is stored in the assigned electronic folder. Similar to the permission rules and levels assigned to each business element as described in the disclosure with respect to FIG. 1, each folder may be assigned folder access permission rules to govern access to the actionable business plan contained in the folder and each user may be assigned access permission levels to define which folders the user may access 212. At step 214, the user is restricted access to folders based on the assigned folder access permission rules for each folder and the corresponding access permission levels for each user. Restricting access to folders may be used to permit a business consultant to maintain a system that holds actionable business plans for multiple businesses. The consultant may have permission to view all folders on the system, but representatives of each individual company may have permission to access only folders containing actionable business plans owned by the user's company. As described in the disclosure with respect to FIG. 1, each business element may also be assigned business element access permission rules to govern how and which users may interact with the business element 216. At step 218, the user is restricted access to business elements based on the assigned element access permission rules for each business element and the corresponding access permission levels for each user. Restricting some users access to specific business elements permits the system to show only the items directly related to a user's job function (i.e., role-based access) and also permits confidential information to be denied to unauthorized personnel. The process ends 220 when the actionable business plan execution is completed.

The electronic folder may be created on a computer readable medium using a database storage system, a binary file, a text file, a plurality of related electronic files, or any other computer data storage scheme. The electronic file may further be integrated with the structure of the actionable business plan electronic file to create a global data storage structure for multiple business plans. In the global data storage structure, the electronic folder is an extension of the parent/child hierarchy of the actionable business plan. Thus, the electronic folder is the parent of the actionable business plan assigned to the folder.

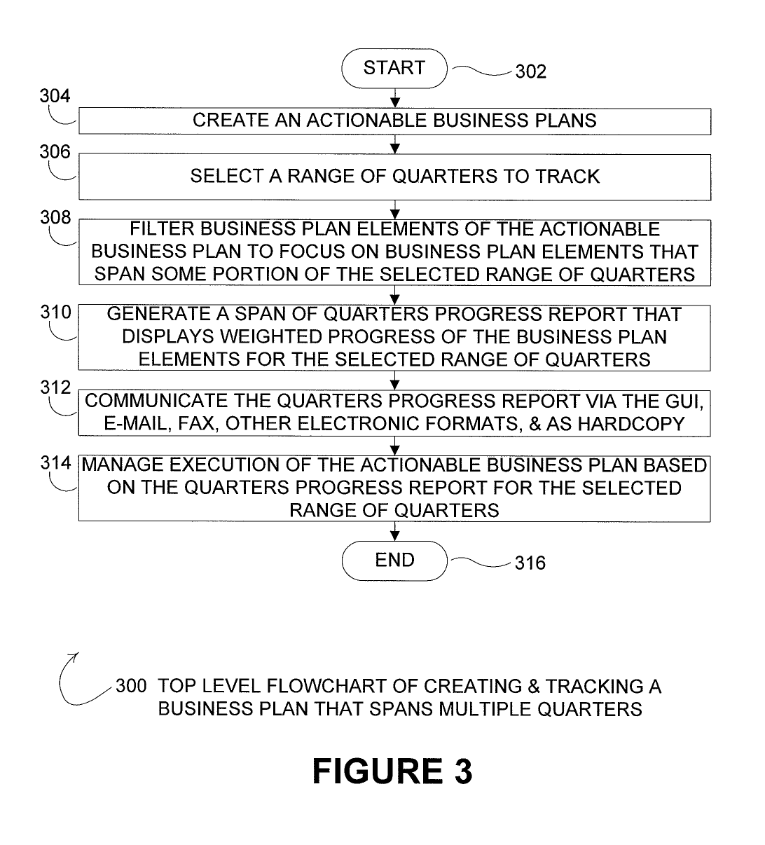

FIG. 3 is a flowchart 300 describing a top-level view of the process for creating and tracking an actionable business plan that spans multiple quarters. To start 302, create an actionable business plan 304. The steps to create an actionable business are described in the disclosure with respect to FIG. 1. After the actionable business plan is created 302, select a range of quarters to track 306. In this instance, a quarter refers to a calendar quarter. A calendar quarter is a quarter of a year, or three months. For a typical year; the first quarter is the months of January, February, and March; the second quarter is the months of April, May, and June; the third quarter is the months of July, August, and September; and the fourth quarter is the months of October, November, and December. Some companies perform their accounting on a non-standard year. For instance a company may select October as the first month of their fiscal year. When a company's calendar does not match a standard calendar, the designation of the quarters would be adjusted to meet the circumstances of the company's calendar. Once the range of quarters is selected in step 306, the business elements of the actionable business plan are filtered to focus on the business elements that span some portion of the selected range of quarters 308. A business element is included if even a small portion falls within the selected range of quarters. Accordingly, a business element that has actions that extend one week into the selected range of quarters will be included in a report on the quarters. Using the filtered business elements, a span of quarters progress report is generated 310. The span of quarters progress report displays the weighted progress of the business plan elements for the selected range of quarters. The span of quarters progress report is then communicated to the user via the GUI, e-mail, facsimile, other electronic communications format, and/or hardcopy 312. The user then manages the execution of the actionable business plan based on the span of quarters progress report 314. The process ends 316 when the actionable business plan execution is completed.

For reports within the actionable business plan system, each business element may be assigned a weight value. The weight value for each business element defines the relative importance of a business element compared to other business elements. For example, one business element may have a low weight and one business element may have a high weight. When a weighted progress report is generated slips in the low weighted schedule will not downgrade the overall progress as much as slips in the business element with a high weight value. In the simplest example, the weight value for each business element is multiplied times the raw progress value for the business element to obtain a weighted progress value. The weight values for the business elements may be used in the span of quarters report. One possible calculation for the span of quarters report includes performing a weighted average calculation for progress of only items and actions that appear and are due during the span of quarters report. Thus, the quarters progress report displays progress status for the business elements that have actions in the selected range of quarters. A second possible calculation for the span of quarters report includes performing a weighted average calculation for the business elements that have actions within the selected range of quarters against the progress of the business elements for the entire life of the actionable business plan. For example, the first calculation may indicate that actions necessary for business elements for a selected range of quarters is eighty percent complete when compared to the total possible actions for the selected range of quarters. If the selected range of quarters covers only a quarter of the possible actions for the entire project, the second calculation may indicate that twenty percent of the actions for the business elements are complete when compared to the total possible actions for the business elements during the life of the actionable business plan. The results of the two calculations may be displayed to the user at the same time. In one embodiment a bar graph running horizontally may indicate the progress of the business elements during the selected range of quarters. A second bar graph, either over or under the first bar graph, may indicate the progress of the business elements during the life of the actionable business plan. Another embodiment may rotate the bar graphs to run vertically instead of horizontally.

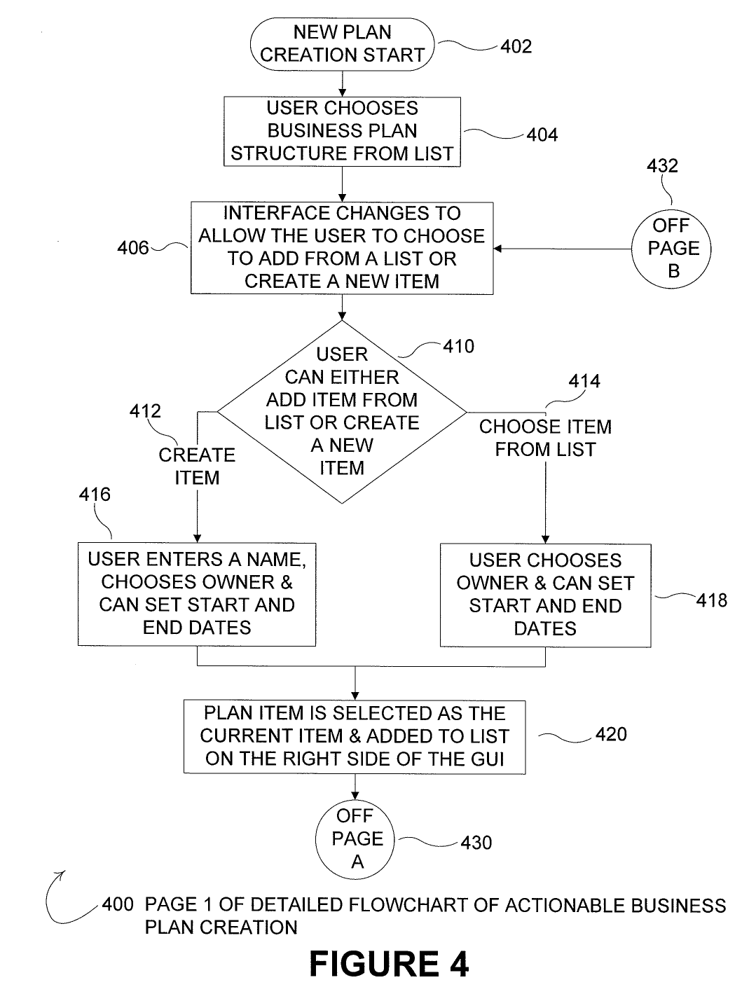

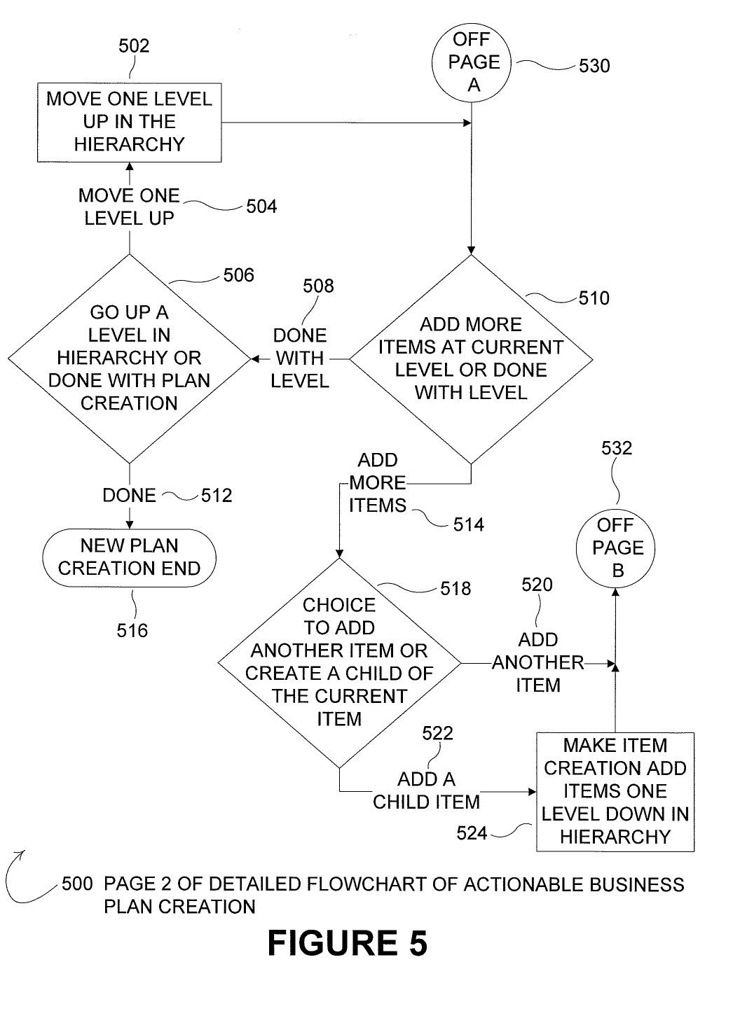

FIG. 4 and FIG. 5 are a first page 400 and a second page 500 of a flowchart describing a detailed view of the process for the creation of an actionable business plan. At the start of creating a new actionable business plan 402, the user chooses a business plan structure from a predetermined list of possible business plan structures 404. The interface then changes to allow the user to choose to add business elements from a list or to create a new business element 406. A business element may also be referred to as an item, an element, or a plan element. After the user interface changes to show the proper view 406, the user may then either add an item from the list or create a new item 410. If the user chooses to create a new item 412, the user enters a name for the item, chooses an owner for the item, and may define the start and end dates for the item 416. If the user chooses to add an item from a list 414, then the user chooses the item from the list, chooses an owner for the item, and may set the start and end dates for the item 418. Both steps 416 (creating an item) and 418 (choosing an item from a list) feed into step 420. At step 420, the new plan item is selected as the current item and the new plan item is added to a list of items on the right side of the GUI 420. The location of displays of information on the GUI is a design choice made by the developer of the actionable business plan system. While one embodiment places the list of items (aka., business elements) on the right side of the GUI, the list may just as well be on the left side, top, bottom, or middle of the screen as well as in a completely different window.

Once the new item is created and placed in the list of items, the next step moves from page one (400) to page two (500) via off page connector A 430 on page one (400) to off page connector A 530 on page two (500). The next functional step 510 asks the user whether to add more items at the current level or if the user is done with the current level. If the user is done with the current level 508, the user is asked whether to go up a level in the hierarchy or if the actionable business plan creation is complete 506. If the user is done creating the business plan 512, the new plan creation is ended 516. If the user chooses to move up one level 504, then the system moves the user up one level 502 and returns to step 510 to ask the user whether to add more items at the current level of the hierarchy, or if the user is done with the current level of the hierarchy. If the user chooses to add more items 514, the user is then asked whether to add another item at the current level of the hierarchy or whether to create a new item as a child of the currently selected item 518. If the user chooses to add the item as a child item 522, then the system makes the item creation functions add items one level down in the hierarchy 524. If the user chooses to add another item at the same hierarchy level 520, the system skips the step of going down one level 524 and moves to the next step of 532. Step 532 connects page two (500) to page one (400) of the flowchart via off page connector B 532 on page two (500) to off page connector B 432 on page one (400). The next functional step is step 406, which changes the GUI to allow the user to choose to add the item from a list or to create a new item. Step 406 flows into step 410 and the following steps as described above until the user chooses to end the business plan creation at step 516.

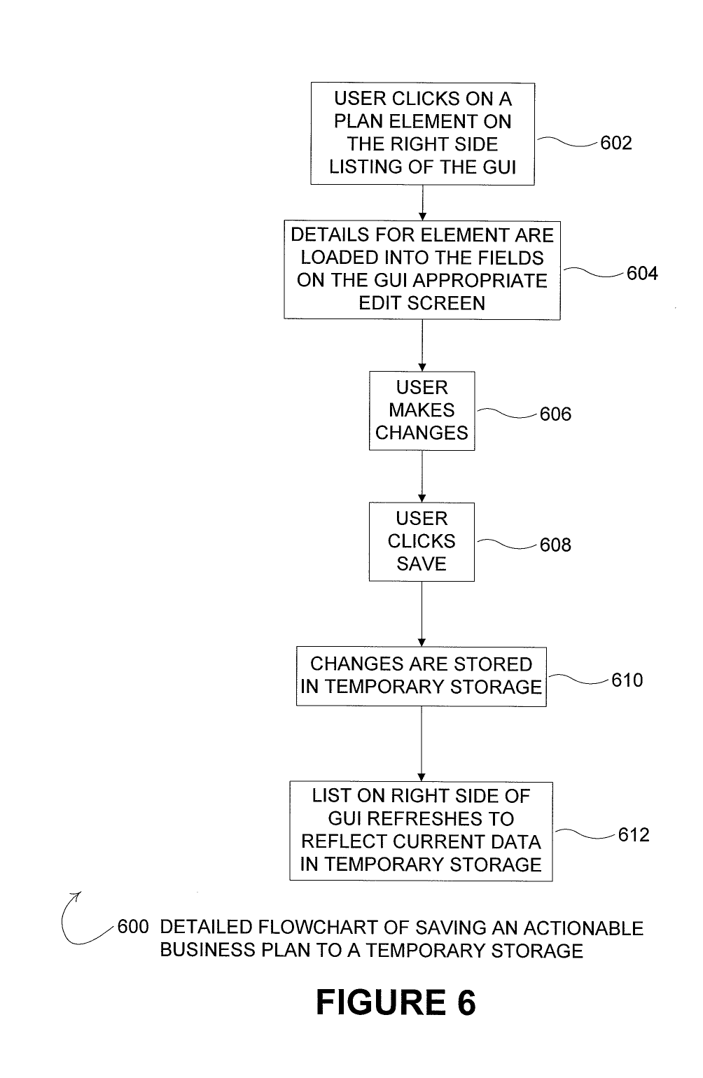

FIG. 6 is a flowchart 600 describing a detailed view of the process for saving an actionable business plan to a temporary storage location. To begin, the user clicks on a plan element on the right side listing shown on the GUI 602. Again, the location of information on the GUI is a matter of design choice for the developer implementing the actionable business plan system and the listing may be shown anywhere within the GUI. Once the user selects the plan element, details for the element are loaded into the fields on the appropriate edit screen of the GUI 604. The user then makes any desired changes 606 and clicks to save the changes 608. The changes are then put into temporary storage 610. The list on the right side of the GUI refreshes to reflect the current data contained in temporary storage 612. By putting the items into temporary storage, the system responds more quickly and undoing changes is more easily accomplished. Temporary changes are also not available to all users, so a user may experiment with different scenarios without affecting other users of the system.

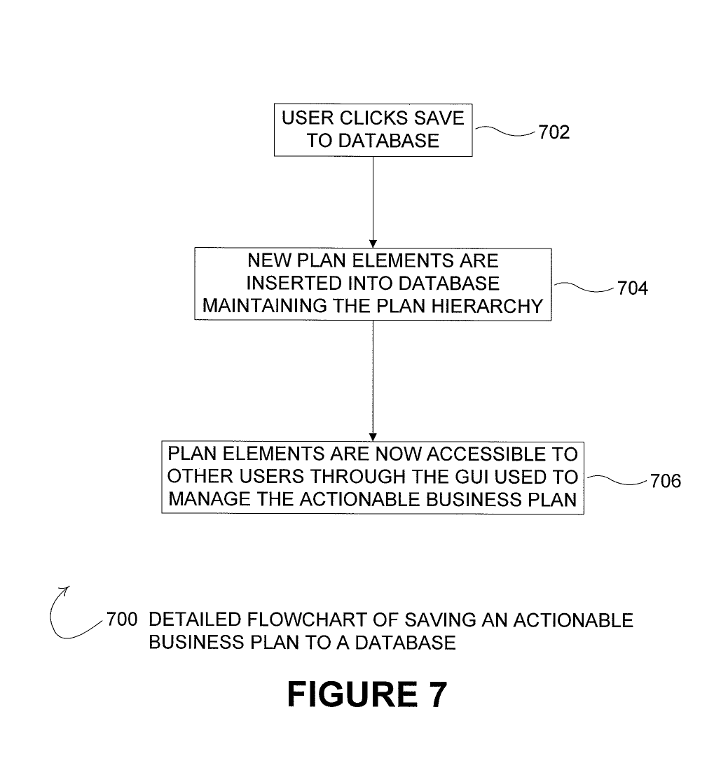

FIG. 7 is a flowchart 700 describing a detailed view of the process for saving an actionable business plan to a database. To begin, the user clicks on a selection to save to a database 702. Some embodiments may not use a database as permanent storage, thus, the selection for step 702 may be to save to permanent storage. Once the user has selected to save the data to the database 702, the new plan elements are inserted into the database, or other permanent storage medium, while maintaining the business plan hierarchy 704. The plan elements are now accessible to other users through the GUI 706.

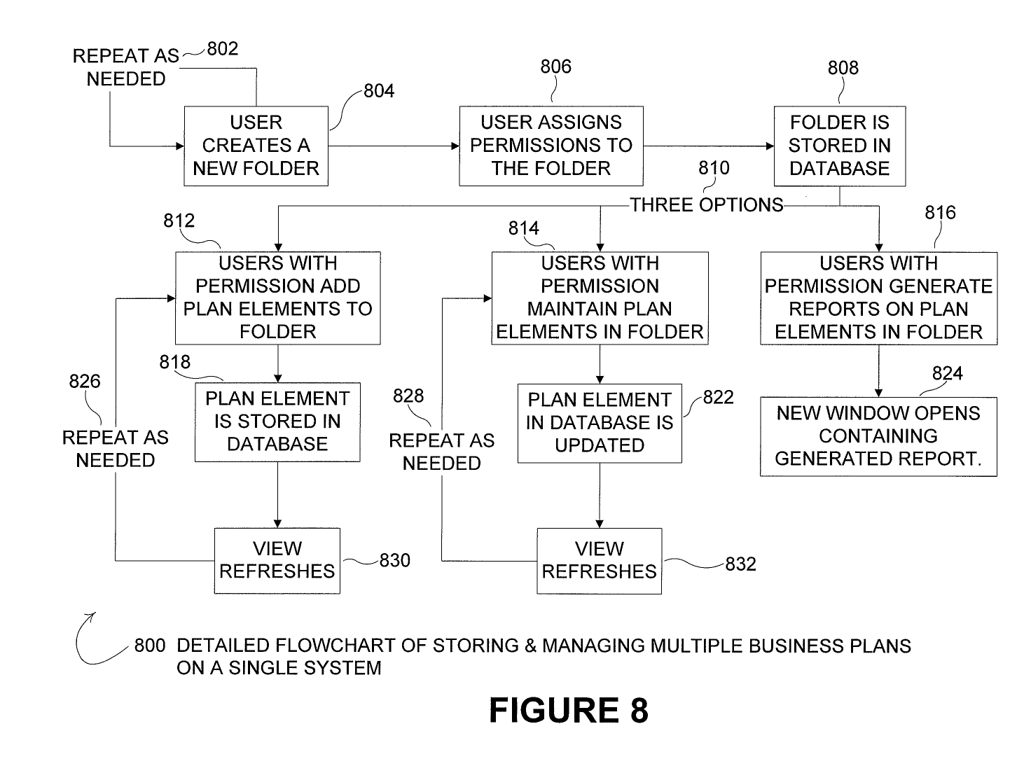

FIG. 8 is a flowchart 800 describing a detailed view of the process for storing and managing multiple actionable business plans on a single system. The user begins by creating a new folder to store an actionable business plan 804. Step 804 may be repeated 802 as necessary to create folders to hold multiple actionable business plans. For each folder, the user then assigns permission rules to the folder 806. The folder is then stored in the database or other permanent storage system 808. There are then three options 810 based on user permission levels. The first option at step 812 allows users with the proper permission levels to add plan elements to the folder. Each new plan element is stored in the database or other permanent storage system 818 and the GUI view is refreshed 830. Steps 812, 818, and 830 are repeated 826 as necessary to create the actionable business plan within the folder. The second option at step 814 allows users with permission to maintain elements in the folder. For the second case the user is not adding new items, but is changing and/or updating business plan elements as the actionable business plan is executed. After the user's permission levels are verified in step 814, the changed or updated business plan element is updated in the database or other permanent storage system 822. The GUI view is then refreshed to display the changes or updates 832. Steps 814, 822, and 832 are repeated 828 as necessary to make the desired changes and/or updates to the business plan elements. The third option at step 816 allows users with proper permission levels to generate reports on business plan elements in the folder. Once the report is selected in step 816, a new window opens containing the freshly generated report 824. Other embodiments may not require that a new window is generated, but may place the report on the current window of the GUI. For the third case, the user does not need to update the database with new elements or updates to elements, so changes are not made to the database or other permanent storage system. Thus, the user need only have read permission levels to perform the third option.

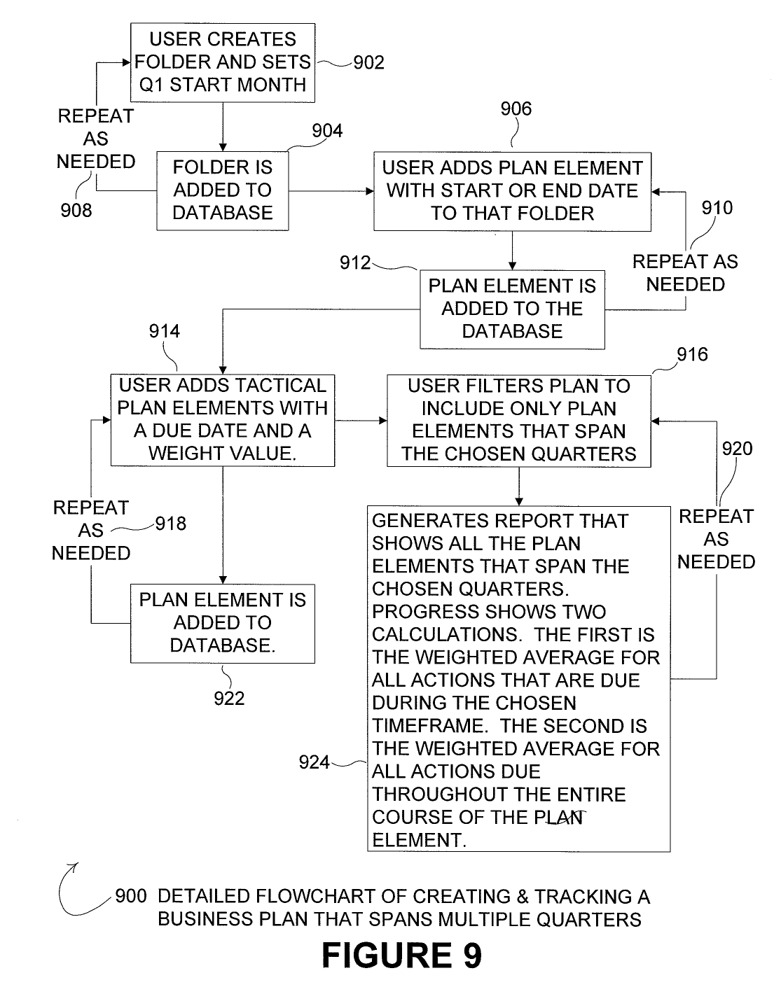

FIG. 9 is a flowchart 900 describing a detailed view of the process for creating and tracking a business plan that spans multiple quarters. The user begins by creating a folder and setting the first quarter (Q1) starting month 902. Choosing the first quarter starting month permits the actionable business plan system to adjust to match a company's financial calendar. Once the folder is created 902, the folder is added to the database or other permanent storage system 904. The steps for adding folders may be repeated 908 as needed to create multiple business plans. After the folder has been added to the permanent storage 904, the user then adds plan elements with start and/or end dates into the folder 906. The plan element is then added to the database or other permanent storage system 912. Steps 906 and 912 for creating business plan elements may be repeated 910 as necessary to create a complete actionable business plan. Once plan elements have been added in steps 906 and 912, the user then adds a tactical plan element with a due date and a weight value 914. The tactical plan element is then added to the database or other permanent storage system 922. Steps 914 and 922 are repeated 918 as necessary to add all desired tactical plan elements. Once all tactical plan elements have been added in steps 914 and 922, the user then may filter the actionable business plan to include only business plan elements that span a chosen set of quarters 916. A report is then generated in step 924 that shows the plan elements that span the chosen quarters. The report of step 924 may contain the results of two calculations. The first possible calculation is a weighted average for all actions that are due during the chosen timeframe (i.e., the chosen quarters). The second possible calculation is the weighted average for all actions due throughout the entire course of the plan elements.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method to create and execute an actionable business plan comprising:
creating a business plan storage structure on a computer readable storage medium, said computer readable storage system being part of a computer system;
gathering business plan information for said actionable business plan from a business plan construction user by having an interactive knowledgebase guide said business plan construction user through a series of questions where suitable questions are selected based on prior responses to previous questions;
separating said business plan information into separate business elements to create actionable business elements;
dynamically linking said actionable business elements to related actionable business elements;
storing said business plan information in said business plan storage structure employing a hierarchical parent/child storage structure such that an actionable business element that is a piece of a parent element is stored as a child element of said parent element;
presenting said actionable business plan to end users via a Graphical User Interface (GUI);
assigning said actionable business elements to individuals for execution of said actionable business elements by said assigned individuals; and
communicating progress towards completion of said actionable business elements on an ongoing basis.

2. The method of claim 1 wherein said step of communicating progress towards completion of said actionable business elements comprises sending progress reports to said end users.

3. The method of claim 1 wherein said separate business elements are comprised of at least one of the group comprising: business objectives, business strategies, initiatives, programs, deliverables, and metrics and milestones.

4. The method of claim 3 wherein said step of dynamically linking said actionable business elements to said related actionable business elements further comprises dynamically linking said business objectives and said business strategies to said initiatives, said programs, said deliverables, and said metrics and milestones that support said business objectives and said business strategies.

5. The method of claim 1 further comprising: managing execution of said actionable business plan based on said progress reports.

6. The method of claim 2 wherein said progress reports are communicated via at least one of the group comprising: said GUI, e-mail, text messaging, facsimile, other electronic formats, and hard copy.

7. The method of claim 1 wherein said GUI is made available via a web browser.

8. The method of claim 7 wherein said web browser is available on said computer system and on other computers connected via a network connection.

9. The method of claim 1 wherein each question in said series of questions has an acceptable response restricted to a predetermined list of possible answers.

10. The method of claim 9 further comprising said business plan construction user adding a new possible answer to said predetermined list of possible answers.

11. The method of claim 1 wherein said business plan storage structure is comprised of at least one of the group comprising: a database storage system, a dedicated electronic file, and a plurality of related electronic files.

12. The method of claim 1 further comprising:
assigning access permission rules to each actionable business element of said actionable business elements; and
restricting access to said actionable business elements based on a user permission level and said access permission rules such that individual users are granted access to a subset of said actionable business elements appropriate for each individual user of said individual users.

13. The method of claim 1 further comprising:
repeating said steps of creating said business plan storage structure, gathering said business plan information, separating said business plan information into said separate business plan elements to create said actionable business elements, dynamically linking said actionable business elements to said related actionable business elements, storing said business plan information in said business plan storage file, presenting said actionable business plan to said end user via said GUI, assigning said actionable business elements to said individuals, and communicating progress towards completion of said actionable business elements on an ongoing basis via progress report a plurality times creating a plurality of actionable business plans;
creating a plurality of electronic folders such that there is an electronic folder for each actionable business plan of said plurality of actionable business plans on said computer readable storage medium;
storing said business plan storage structure of each actionable business plan of said plurality of actionable business plans within said electronic folder of each actionable business plan of said plurality of actionable business plans.

14. The method of claim 13 further comprising:
creating a global storage structure on said computer readable storage medium; and
storing said electronic folder containing said business plan storage structure of each actionable business plan of said plurality of actionable business plans in said global storage structure.

15. The method of claim 14 wherein said global storage structure is comprised of at least one of the group comprising: a database storage system, a dedicated electronic file, and a plurality of related electronic files.

16. The method of claim 13 further comprising:
assigning access permission rules to each electronic folder of said plurality of electronic folders; and
restricting access to each electronic folder of said plurality of electronic folders based on a user permission level and said access permission rules such that individual users are granted access to a subset of said plurality of electronic folders appropriate for each individual user of said individual users.

17. The method of claim 1 further comprising:
assigning a weight value to each actionable business element of said actionable business elements;
selecting a range of calendar quarters to track;
filtering said actionable business elements into a selected range of calendar quarters subset of said actionable business elements such that actionable business elements that have due dates that span said selected range of quarters are included in said selected range of calendar quarters subset of said actionable business elements; and
generating a selected quarters progress report that displays a weighted progress of said selected range of calendar quarters subset of said actionable business elements.

18. The method of claim 17 wherein said selected quarters progress report displays said weighted progress of said selected range of calendar quarters subset of said actionable business elements as weighted averages calculated with regard to actions due during said selected range of quarters for said selected range of calendar quarters subset of said actionable business elements.

19. The method of claim 17 wherein said selected quarters progress report displays said weighted progress of said selected range of calendar quarters subset of said actionable business elements as weighted averages calculated with regard to actions due during the entirety of said actionable business plan.

20. An actionable business plan creation and execution system comprising:
a computer system containing a computer readable storage medium that stores a business plan storage structure;
a business plan information gathering subsystem that gathers business plan information for said actionable business plan from a business plan construction user by having an interactive knowledgebase guide said business plan construction user through a series of questions where suitable questions are selected based on prior responses to previous questions;
an actionable business elements subsystem that separates said business plan information into separate business elements to create actionable business elements, dynamically links said actionable business elements to related actionable business elements, and stores said business plan information in said business plan storage structure employing a hierarchical parent/child storage structure such that an actionable business element that is a piece of a parent element is stored as a child element of said parent element; and
a user interaction subsystem that presents said actionable business plan to end users via a Graphical User Interface (GUT), permits end users to assign said actionable business elements to individuals for execution of said actionable business elements by said assigned individuals, and communicates progress towards completion of said actionable business elements on an ongoing basis.

21. The actionable business plan creation and execution system of claim 20 wherein said user interaction subsystem communicates progress towards completion of said actionable business elements by sending progress reports to said end users.

22. The actionable business plan creation and execution system of claim 20 wherein said separate business elements are comprised of at least one of the group comprising: business objectives, business strategies, initiatives, programs, deliverables, and metrics and milestones.

23. The actionable business plan creation and execution system of claim 22 wherein said actionable business elements subsystem dynamically links said actionable business elements to related actionable business elements by dynamically linking said business objectives and said business strategies to said initiatives, said programs, said deliverables, and said metrics and milestones that support said business objectives and said business strategies

24. The actionable business plan creation and execution system of claim 20 wherein said business plan storage structure is comprised of at least one of the group comprising: a database storage system, a dedicated electronic file, and a plurality of related electronic files.

25. The actionable business plan creation and execution system of claim 20 further comprising:
a business element access permission subsystem that permits said end user to assign access permission rules to each actionable business element of said actionable business elements, and that restricts access to said actionable business elements based on a user permission level and said access permission rules such that individual users are granted access to a subset of said actionable business elements appropriate for each individual user of said individual users.

26. The actionable business plan creation and execution system of claim 20 further comprising:
a multiple business plan handling subsystem that creates a plurality of electronic folders such that there is an electronic folder for each actionable business plan of a plurality of actionable business plans on said computer readable storage medium, and stores said business plan storage structure of each actionable business plan of said plurality of actionable business plans within said electronic folder of each actionable business plan of said plurality of actionable business plans.

27. The actionable business plan creation and execution system of claim 26 wherein said multiple business plan handling subsystem further creates a global storage structure on said computer readable storage medium, and stores said electronic folder containing said business plan storage structure of each actionable business plan of said plurality of actionable business plans in said global storage structure.

28. The actionable business plan creation and execution system of claim 27 wherein said global storage structure is comprised of at least one of the group comprising: a database storage system, a dedicated electronic file, and a plurality of related electronic files.

29. The actionable business plan creation and execution system of claim 26 further comprising:
a folder access permission subsystem that assigns access permission rules to each electronic folder of said plurality of electronic folders, and restricts access to each electronic folder of said plurality of electronic folders based on a user permission level and said access permission rules such that individual users are granted access to a subset of said plurality of electronic folders appropriate for each individual user of said individual users.

30. The actionable business plan creation and execution system of claim 20 further comprising:
a calendar quarter subsystem that permits said end user to assign a weight value to each actionable business element of said actionable business elements, further permits said end user to select a range of calendar quarters to track, filters said actionable business elements into a selected range of calendar quarters subset of said actionable business elements such that actionable business elements that have due dates that span said selected range of quarters are included in said selected range of calendar quarters subset of said actionable business elements, and generates a selected quarters progress report that displays a weighted progress of said selected range of calendar quarters subset of said actionable business elements.

31. The actionable business plan creation and execution system of claim 30 wherein said selected quarters progress report displays said weighted progress of said selected range of calendar quarters subset of said actionable business elements as weighted averages calculated with regard to actions due during said selected range of quarters for said selected range of calendar quarters subset of said actionable business elements.

32. The actionable business plan creation and execution system of claim 30 wherein said selected quarters progress report displays said weighted progress of said selected range of calendar quarters subset of said actionable business elements as weighted averages calculated with regard to actions due during the entirety of said actionable business plan.

33. An actionable business plan creation and execution system comprising:
means for creating a business plan storage structure on a computer readable storage medium, said computer readable storage system being part of a computer system;
means for gathering business plan information for said actionable business plan from a business plan construction user;
means for separating said business plan information into separate business elements to create actionable business elements;
means for dynamically linking said actionable business elements to related actionable business elements;
means for storing said business plan information in said business plan storage structure;
means for presenting said actionable business plan to end users;
means for assigning said actionable business elements to individuals for execution of said actionable business elements by said assigned individuals; and
means for communicating progress towards completion of said actionable business elements.

34. The actionable business plan creation and execution system of claim 33 further comprising:
means for creating a plurality of electronic folders such that there is an electronic folder for each actionable business plan of a plurality of actionable business plans on said computer readable storage medium;
means for storing said business plan storage structure of each actionable business plan of said plurality of actionable business plans within said electronic folder of each actionable business plan of said plurality of actionable business plans.

35. The actionable business plan creation and execution system of claim 33 further comprising:
means for assigning a weight value to each actionable business element of said actionable business elements;
means for selecting a range of calendar quarters to track;
means for filtering said actionable business elements into a selected range of calendar quarters subset of said actionable business elements; and
means for generating a selected quarters progress report.
